(19) United States
(12) Patent Application Publication
(10) Pub. No.: US 2025/0330478 A1
(43) Pub. Date: Oct. 23, 2025

(54) SYSTEM AND METHOD FOR ELIMINATING DUPLICATE CORRELATION CHAINS OF EVENTS DURING DETECTION OF INFORMATION SECURITY INCIDENTS

(71) Applicant: AO Kaspersky Lab, Moscow (RU)

(72) Inventor: Ivan S. Lyukshin, Moscow (RU)

(21) Appl. No.: 19/169,569

(22) Filed: Apr. 3, 2025

(30) Foreign Application Priority Data
Apr. 19, 2024 (RU) 2024110880

(51) Int. Cl. H04L 9/40

(52) U.S. Cl. CPC H04L 63/1416

(57) ABSTRACT

Disclosed are system and methods for eliminating duplicate correlation chains of events during detection of information security incidents. An example method comprises receiving information from a plurality of computers in the network; generating an event based on the received information, wherein each generated event contains attributes; identifying at least one correlation chain in a database, wherein, for the first event of each identified correlation chain, attributes are set based on a corresponding correlation rule; comparing the generated event with the first event from each identified correlation chain, including determining the similarity of attributes, and further comprising: merging an event with a correlation chain if the generated event is a duplicate event for the first event in the correlation chain, and creating a new correlation chain if the attributes of the generated event are not similar to the attributes of the first event in the correlation chain.

### CROSS REFERENCE TO RELATED APPLICATIONS

The present application claims benefit of priority to a Russian Application No. 2024110880 filed on Apr. 19, 2024, and which is incorporated by reference herein.

### FIELD OF TECHNOLOGY

The present disclosure relates generally to the technical field of information security, and more specifically to the systems and method for eliminating duplicate correlation chains of events when detecting information security incidents.

### BACKGROUND

In today's environment, corporate computer systems and networks are continually exposed to a range of malicious software (i.e., malware), such as viruses, worms, keyloggers, and ransomware, as well as various computer attacks, including targeted attacks and advanced persistent threats. Attackers can have a variety of goals, from simple theft of employees' personal data to industrial espionage. Often, before carrying out an attack on the corporate infrastructure of companies, attackers have information about the architectures of corporate networks, the principles of internal document management, and the information security tools used, which significantly increases the likelihood of a successful attack.

Existing technologies for protecting information from malicious software and computer threats, including signature analysis, heuristic analysis, and emulation, have several limitations that prevent them from offering sufficient protection against computer threats. For instance, these methods often fail to detect and analyze previously unknown threats, malicious computer attacks, sophisticated attacks that employ evasion techniques, and prolonged attacks that can persist for several days to years.

Security Information and Event Management (SIEM) systems are increasingly utilized to safeguard corporate infrastructure. These systems automate the collection and processing of a vast array of information security (IS) events from various security tools deployed across user computers, servers, network equipment, controllers, and other devices within the corporate environment. SIEM systems enable the early detection of computer attacks and the identification of information security incidents. This is achieved through the correlation of security events, which involves analyzing the relationships between different events based on predefined rules and automatically generating incidents when these rules are met.

Simultaneous occurrences of different information security events are not uncommon, often due to various factors. One such factor is the lack of synchronization among the clocks of sensors, which serve as event sources. For instance, a sensor in Kaspersky Lab's KICS for Networks product is designed to receive and analyze data from computer networks connected via network interfaces. This sensor is installed on a separate computer and sends its analysis results to a server. Additionally, time delays in event reception can occur when traffic is processed by different sensors, with delays ranging from milliseconds to minutes. These issues can lead to missed or improperly formed information security incidents.

Duplicate events present another challenge, as they can occur at varying time intervals, such as every 5, 10, or 20 seconds, or even simultaneously.

This situation presents a technical challenge characterized by the occurrence of duplicate events. These duplicates can result in important IS events being overlooked and not receiving the appropriate response, potentially leading to negative consequences.

### SUMMARY

The present invention aims to address at least some of the deficiencies associated with existing methods for maintaining information security within corporate infrastructure, particularly in the context of event correlation. The technical benefit of this invention is the reduction of false positives in the detection of information security incidents by eliminating duplicate correlation chains of events.

In one example aspect, a method for eliminating duplicate correlation chains of events during detection of information security incidents comprises: receiving information from a plurality of computers in the network; generating an event based on the received information, wherein each generated event contains attributes; identifying at least one correlation chain in a database, wherein, for the first event of each identified correlation chain, attributes are set based on a corresponding correlation rule; comparing the generated event with the first event from each identified correlation chain, including determining the similarity of attributes, and further comprising: merging an event with a correlation chain if the generated event is a duplicate event for the first event in the correlation chain, and creating a new correlation chain if the attributes of the generated event are not similar to the attributes of the first event in the correlation chain.

In another aspect, if the attributes of the generated event are not similar to the first event from at least one correlation chain, then comparing the generated event with subsequent events from each identified correlation chain using other correlation rules.

In another aspect, if the generated event corresponds to the next event from at least one correlation chain, according to the correlation rule, then adding the generated event to the corresponding correlation chain.

In another aspect, if the correlation chain corresponds with the correlation rule, an information security incident is identified.

In another aspect, the information from the computers in the network includes at least information about an unauthorized network connection, registration of a new device on the network, disconnection of the sensor or controller, and/or unauthorized access to the computer.

In another aspect, the similarity of the event attributes is determined according to the correlation rule during a timeout.

In another aspect, the attributes of the event comprise at least a source of the event, a type of event, and/or a timestamp.

In another aspect, the sources of the event includes the security features installed on the computers and/or the security software.

In another example aspect, a system for eliminating duplicate correlation chains of events during detection of information security incidents comprises a hardware processor configured to: receive information from a plurality of computers in the network; generate an event based on the received information, wherein each generated event contains attributes; identify at least one correlation chain in a database, wherein, for the first event of each identified correlation chain, attributes are set based on a corresponding correlation rule; compare the generated event with the first event from each identified correlation chain, including determining the similarity of attributes, and further comprising: merge an event with a correlation chain if the generated event is a duplicate event for the first event in the correlation chain, and create a new correlation chain if the attributes of the generated event are not similar to the attributes of the first event in the correlation chain.

In another example aspect, a non-transitory computer readable medium storing thereon computer executable instructions for eliminating duplicate correlation chains of events during detection of information security incidents, including instructions for: receiving information from a plurality of computers in the network; generating an event based on the received information, wherein each generated event contains attributes; identifying at least one correlation chain in a database, wherein, for the first event of each identified correlation chain, attributes are set based on a corresponding correlation rule; comparing the generated event with the first event from each identified correlation chain, including determining the similarity of attributes, and further comprising: merging an event with a correlation chain if the generated event is a duplicate event for the first event in the correlation chain, and creating a new correlation chain if the attributes of the generated event are not similar to the attributes of the first event in the correlation chain.

### BRIEF DESCRIPTION OF DRAWINGS

The accompanying drawings, which are incorporated into and constitute a part of this specification, illustrate one or more example aspects of the present disclosure and, together with the detailed description, serve to explain their principles and implementations.

FIG. 1 illustrates a diagram of a system for eliminating duplicate correlation chains during detection of information security incidents.

FIG. 2A illustrates an example of correlation chains created based on correlation rules.

FIG. 2B illustrates an example a method of creating duplicate correlation chains.

FIG. 2C illustrates an example of applying a correlation rule with setting the attributes of the first event in the correlation chain.

FIG. 3 illustrates a method for eliminating duplicate correlation chains of events during detection of information security incidents.

FIG. 4 illustrates an example of a computer system on which variant aspects of system and methods disclosed herein may be implemented.

### DETAILED DESCRIPTION

Exemplary aspects are described herein in the context of a system, method, and computer program product for eliminating duplicate correlation chains when detecting information security incidents. Those of ordinary skill in the art will realize that the following description is illustrative only and is not intended to be in any way limiting. Other aspects will readily suggest themselves to those skilled in the art having the benefit of this disclosure. Reference will now be made in detail to implementations of the example aspects as illustrated in the accompanying drawings. The same reference indicators will be used to the extent possible throughout the drawings and the following description to refer to the same or like items.

A number of terms are defined below, which will be used in the description of the embodiments of the invention.

An information security (IS) event (hereinafter referred to as an event) is an identified occurrence of a certain state of a system, service or network indicating a possible violation of the IS policy or a failure of protective measures, or the occurrence of a previously unknown situation that may be related to security. An event can also be an incident.

An IS incident (hereinafter referred to as an incident) is the occurrence of one or more undesirable or unexpected information security events, which are associated with a significant probability of compromising business operations and creating a threat to information security. An incident can consist of a single event.

Correlation is an analysis of relationships between different events using specified correlation rules.

A correlation chain is a sequence of events combined into a common collection.

File antivirus is a module of antivirus software. File antivirus contains the functionality of detecting malicious activity of all files that are opened, launched, and saved on the user's computer. File antivirus helps to protect the computer's file system from malware.

SIEM systems are a class of software products designed to collect and analyze information about security events. The tasks of SIEM systems may include:
real-time monitoring of alarms from network devices and applications;
processing of the received data and finding relationships between them;
identification of deviations from the normal behavior of controlled systems;
notification of operators about detected incidents.

SIEM solutions can collect data about security events using applications such as antivirus programs, intrusion detection and prevention systems (IDS, IPS), domain controllers, etc., directly from log files, directly from network devices, or using streaming protocols (SNMP, Netflow, IPFIX).

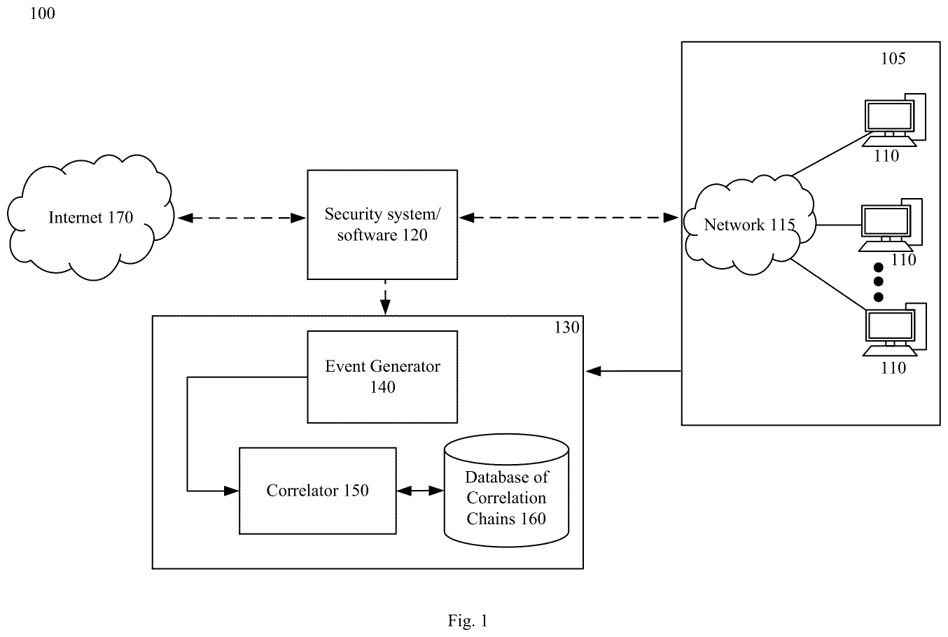

FIG. 1 illustrates a diagram of a system 100 for eliminating duplicate correlation chains during detection of information security incidents. In one example aspect, system 100 comprises an information system 105 (which may be a corporate infrastructure) including a set of computers 110 included in the network 115, a security system/software 120, server 130 comprising at least an event generator 140, a correlator 150, and a database of correlation chains 160. For the purposes of this application, computers 110 include any computing device, such as PC, laptops, smartphones, communication devices such as routers, switches, hubs, etc and sensors. In this case, the computers 110 are equipped with security software, e.g., antivirus software. An example of a network 115 is a corporate Intranet.

In one aspect, server 130 may be a SIEM system. One example of a SIEM system is Kaspersky Unified Monitoring and Analysis Platform (KUMA) by Kaspersky Lab.

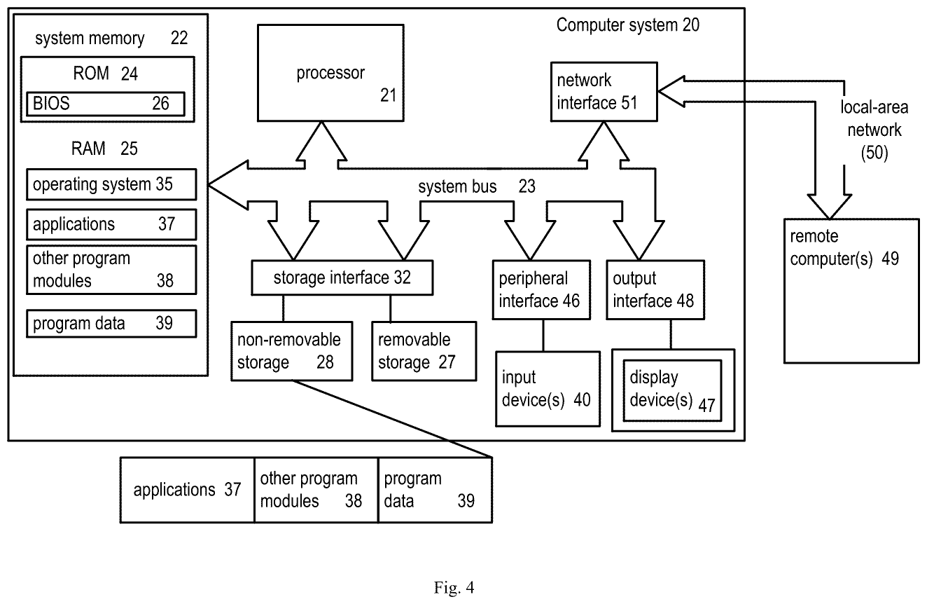

Elements of a system for eliminating duplicate correlation chains during detection of information security incidents 100 may be implemented on a computer system, an example of which is presented in FIG. 4.

Security system/software 120 is designed to analyze the network activity of information system 105. In one aspect, security system/software 120 further analyzes accesses by computers 110 to sources (URLs/URIs) on the Internet 170, e.g., to protect information system 105 from the possibility of being mapped from the outside. The security and/or antivirus software installed on computers 110 are event sources. The security system/software 120 may also serve as an event source. For instance, when analyzing network activity, the security system/software 120 can detect a network connection originating from an IP address on the Internet 170.

In one aspect, security system/software 120 may include an intrusion detection system (IDS) and/or an intrusion prevention system (IPS).

In one aspect, the event generator 140 is designed to generate IS events and transmit them to the correlator 150. In order to generate the events, the event generator 140 on server 130 receives information from computers 110 on network 115, i.e., information related to said computers 110 on network 115. In one aspect, the information from computers 110 is understood to be at least information related to the triggered antivirus record of the file antivirus. The event generator 140 generates events based on this information.

In one aspect, information received from computers 110 on network 115 is first collected by security system/software 120 and transmitted to event generator 140.

Events generated by the event generator 140 contain at least event attributes, including, but not limited to the event source, event type, and timestamp.

The sources of the events are the security and/or antivirus software installed on the computers 110 as well as the security system/software 120.

The type of event can be, for example, the triggering of an IDS, an attempt to connect to a Wi-Fi network, or the connection of an untrusted external device. The listed event types are not exhaustive and imply various other types of events. Additionally, in a particular implementation example, events include a level of criticality depending on the type of event.

The level of criticality of events is divided into low, medium and high. A low criticality level of an event does not require an immediate response to the event. The medium criticality level of events contains information that needs to be paid attention to and needs to be reacted. For example, an attempt to exploit a vulnerability in a protected process is considered to be a medium criticality of an event, and an attempt to connect to a Wi-Fi network is considered to be a low criticality level. A high criticality level of events contains information that can have a critical impact on the process and requires an immediate response. A high criticality level of an event refers to such an event type as activity typical of network attacks.

Timestamp means the time at which an event was received, which can be defined as the time when the security system/software 120 received a network packet containing the data based on which the event was determined.

It is worth noting that the information received by the event generator 140 flows continuously, and accordingly, the event generator 140 constantly receives information from computers 110 and the security system/software 120. The generated events are then transmitted from the event generator 140 to the correlator 150 for subsequent event correlation.

In one aspect, the correlator 150 is designed to perform event correlation using correlation rules. Correlation rules contain conditions for use and actions with the correlation chain. The description of correlation rules can be implemented, for example, using the YAML markup language. The condition for use determines the events (correlation chain) that satisfy the correlation rule for applying actions by the correlator 150. For example, a correlation rule contains a condition where a correlation chain is created upon receiving events A, B, and C, while the correlation rules do not exclude the condition of creating a correlation chain consisting of a single event, such as event A. Actions include, in particular, the creation of an information security incident, which is carried out upon the complete construction of the correlation chain. Additionally, actions may include, for example, creating a new correlation chain, adding an event to an existing correlation chain, destroying a correlation chain, and others. Correlation chains are stored in the database of correlation chains 160 (hereinafter referred to as database 160). The saved correlation chains in database 160 contain the events from which the correlation chains are constructed. The events from which a correlation chain is constructed contain at least an IP address/MAC address identifying the computer 110 from which the event originated, the event type, and a timestamp. A correlation chain is considered created upon receiving the first event.

In one aspect, a correlation rule includes the name of the rule and a list of transitions between the nodes in the correlation chain, which reveals the terms of use and actions on the correlation chain. In addition, a correlation rule can contain the maximum number of events allowed for a chain of events.

In the YAML markup language, a correlation rule can be described as follows:

```
- rule:
  name: “ruleName”
  version: 5
    transitions:
    - transition: {...}
```

The list of transitions is described as follows:
1. The name of the node in the chain from which the transition is made (from).
2. The name of the node in the chain to which the transition is made (to).
3. A predicate, which is a declarative set of conditions for the transition of a chain from node to node to.
4. An action, which is an optional, declarative set of actions performed in case of transition.
5. An indication that the transition can be postponed for a certain time and/or the number of events received (delay, delay count).

A chain node is used to indicate the start (<start>) and end (<end>) of a correlation rule, as well as to indicate the location:

```
transition:
  from: <start>
  to: <end>
  predicate:
  - event: 1
  action:
  - store_attr:
var: event. type
name: type
```

The predicate of the transition of the correlation chain contains the condition for the transition from one node to the next node. A transition condition can be a composite condition of several conditions.

For example, the predicate contains a transition condition that is met when event No. 1000 arrives and provided that the IP address of the event source (event.src_address.ip) matches the specified IP address ($my_ip).
predicate:
   event: 1000
   equal: {var: event.src_address.ip, expect: $my_ip}

Thus, the transition is performed only when the predicate condition is met. When transitioning to the end of the rule (node <end>), the actions specified in the rule will be performed (e.g., an information security incident has been created). Transitioning a correlation chain from one node to another node performs a number of actions, such as determining the current position of the correlation chain, adding an event to the correlation chain, delaying the transition by a certain time and/or the number of events received.

Actions may include, but are not limited to:
Store_attr. This action means storing event attributes by the correlator 150.
Pin_attr. This action means setting event attributes to check for duplicate events.
Ttl. This action means a timeout during which the correlator 150 waits for a new event to be added to the correlation chain. In the special case, when the ttl time expires, the correlation chain will be destroyed by the correlator 150.
Fire_incident. This action means creating an incident by the correlator 150. The fire_incident action is specified in the list of actions only once, and it is allowed to specify several fire_incident actions within one rule.

Events can also contain attributes, such as the following:
MAC address of the source/destination;
IP address of the source/destination;
Event type
The source of the event
Timeout;
Level of criticality.

In one example aspect, the system is implemented as follows: event generator 140 collects information from computers 110 on network 115. The information received by event generator 140 includes at least information about an unauthorized network connection, registration of a new device on the network, disconnection of a sensor or controller, change in controller firmware, unauthorized access to the computer, etc. Event generation 140 generates events based on the information received and transmits the events to the correlator 150. At the same time, each generated event contains attributes.

After the correlator 150 has received the generated events from the event generator 140, the correlator 150 performs their correlation, during which it determines at least one created correlation chain based on the correlation rules. The correlator 150 sets the attributes of the first event in the created correlation chain based on the correlation rule. Sets the attributes of the event according to the correlation rule is carried out by the “pin_attr” action. Then, incoming events are checked for similarity with the first event of the created correlation chains using the same correlation rule. The pin_attr action is aimed at the first event in the created correlation chain, since it is the first event in the correlation chain that creates duplicate correlation chains.

When the correlator 150 receives two events, such as A and D, two correlation chains are created, where the first begins with event A and the second with event D. Correlator 150 then receives 3 events A with the same attributes as the first event in the correlation chain. Correlator 150 checks for similarity these 3 events with the first event of the created correlation chain according to the correlation rule with the set attributes of the event. The specified correlation rule with the set attributes of the event is applied by the correlator 150 to each created correlation chain.

Next, the correlator 150 compares the generated events with the first event from each defined correlation chain, during which the similarity of the event attributes is determined. The similarity of events is determined by the same attributes of these events. For example, the same event attributes are IP or MAC address, as well as the same types of events (triggering of IDS).

If the correlator 150 checks the set attributes of an event and finds similarities between these events, then the event becomes duplicate and merges with the existing correlation chain. If the correlator 150 checks events, but their attributes are not similar to the set attributes in the correlation rule, then a new correlation chain is created.

In one aspect, a correlation rule uses a timeout, which is a variable parameter and is set depending on the correlation rule. A correlation rule with duplicate event detection may have a timeout of at least 60 seconds. Correlator 150 determines the similarity of event attributes according to the correlation rule during the timeout. In a particular implementation, the correlation rule does not contain a timeout.

In one aspect, if the attributes of the generated event are not similar to the first event in at least one correlation chain, then the correlator 150 further compares the generated event to subsequent events from each defined correlation chain using other correlation rules. Other correlation rules are defined as rules that do not seek to identify duplicate events.

As mentioned earlier, a correlation chain can consist of a single event or several consecutive events. An additional comparison of the attributes of the generated event by the correlator 150 on other correlation rules is necessary in cases where the correlation chain consists of several consecutive events and the correlation chain has not yet been fully formed. For example, according to the correlation rule, a correlation chain consists of a sequence of events A-B-C, but such a correlation chain has only received event A. The correlator 150, during the comparison of the generated event, for example, B with event A of the correlation chain, did not identify attribute similarity. However, as mentioned, the correlation chain has not been fully formed, and it is necessary to further check the generated event against other correlation rules to fully form the correlation chain.

If the generated event corresponds to the next event from at least one correlation chain, the generated event is added to the corresponding correlation chain according to the correlation rule.

If the correlation chain matches a correlation rule, the correlator 150 detects an information security incident. At the same time, such a correlation chain with the detected incident will continue to be subject to the correlation rule with the set attributes of the first event until the timeout of such a correlation rule ends.

There are situations where several identical events arrive at the same time, in which case the correlator 150 begins to create duplicate correlation chains. As an example of the occurrence of duplicate correlation chains, consider a correlation rule consisting of two events. The first event, for example, A is an unauthorized UDP network communication (4000002601). The second event, for example, B, is the IDS rule (4000002602) “network scan using TCP segments with the SYN flag set”. Correlator 150 received events A and B from event generator 140, checked on at least one rule and reported the IS incident “Incident A-B”, i.e. a correlation chain with the sequence of events A-B was created.

An example of such a correlation rule:

```
- rule:
  name: “Correlation Rule 1”
  transitions:
    - transition:
      from: <start>
      to: node1
      predicate:
        - event: 4000002601
      action:
        - ttl: 10
    - transition:
      from: node1
      to: <end>
      predicate:
        - event: 4000002602
      action:
        - ttl: 10
        - fire_incident:
          title: “Incident A-B”
```

From the example rule, you can see that in order to create “incident A-B”, the correlator 150 must receive event A first, then event B. However, the example shows a technical problem that causes duplicate correlation chains to be created, for example, when the received event A is checked on the created correlation chain, while the correlator 150 waits for event B to be received from the event generator 140. Suppose that correlator 150 receives at least ten more identical events A from event generator 140. Correlator 150 checks each event A with existing correlation chains, but since event A is already in the existing correlation chain, and correlator 150 is waiting for event B, correlator 150 will start creating new duplicate correlation chains starting with event A.

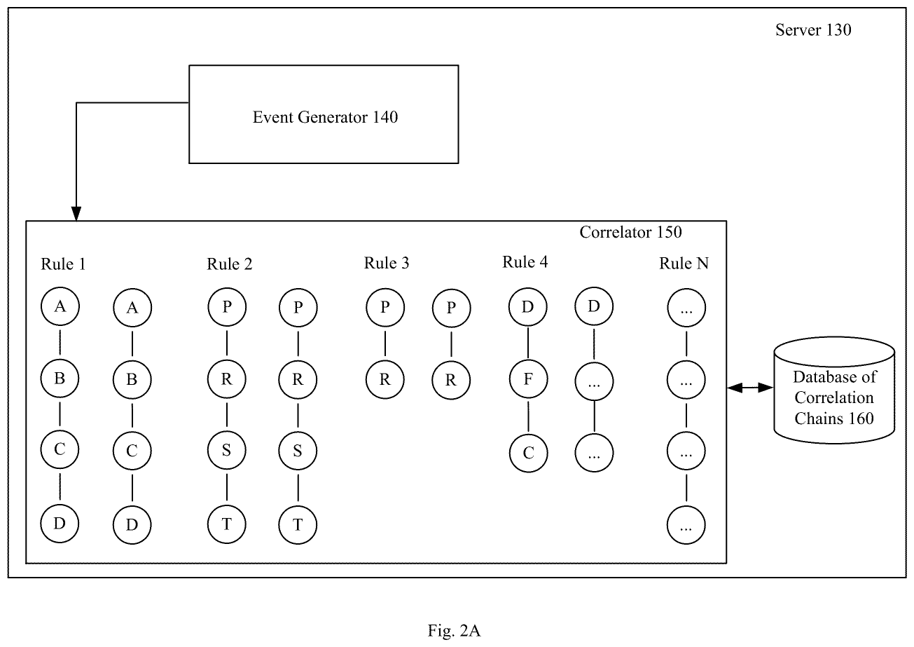

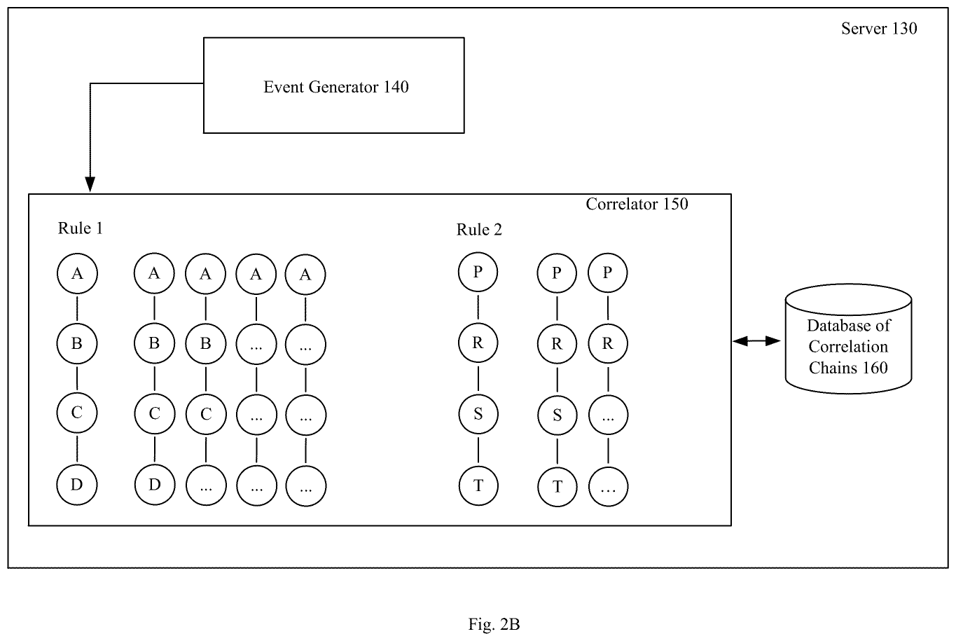

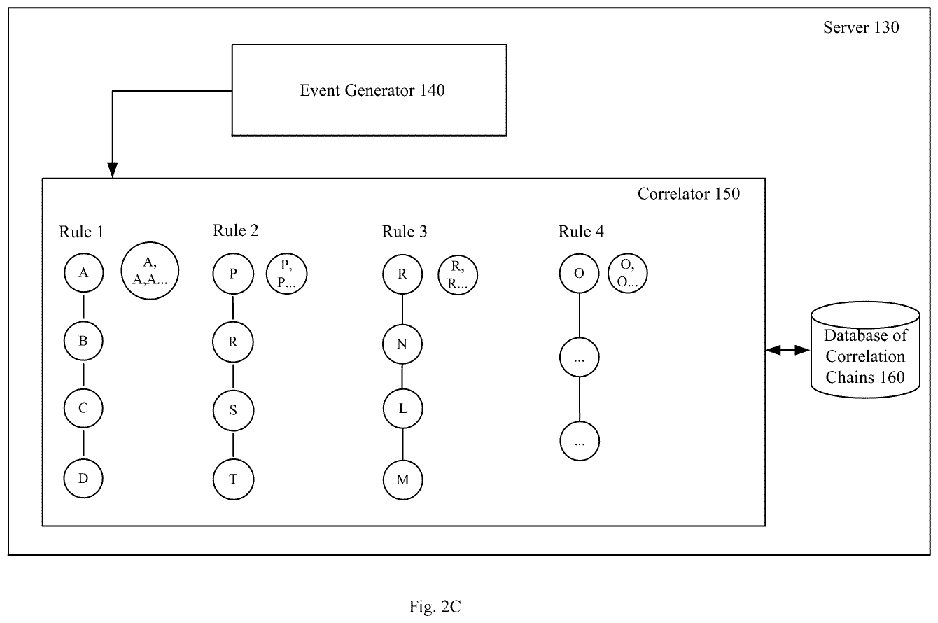

FIG. 2A illustrate an example of correlation chains created by correlator 150 based on correlation rules. Events received by correlator 150 from event generator 140 have been processed according to correlation rules. The example shows that the first correlation chain is created according to rule 1 with the sequence of events A-B-C-D. The second correlation chain is created according to rule 2 c sequence of events P-R-S-T. Accordingly, the correlator 150 created the remaining correlation chains on the basis of other correlation rules and events that satisfy these rules received from the event generator 140. This option demonstrates the processing of events by the correlator 150 without duplicate events. As you can see from the example, correlation chains can consist of a set of several events or a single event. Correlation chains are considered to be created from the moment the first event arrives, regardless of whether the correlation chain is formed to the end or not. For example, according to rule 4 with the sequence of events D-F-C, a correlation chain was created at the first event D, but has not yet been fully formed.

FIG. 2B illustrates an example of the formation of duplicate correlation chains. As in the example of FIG. 2A, the correlator 150 receives events from the event generator 140 for processing according to the correlation rules. The correlator 150 has obtained a large number of identical events A, B, C, D from the event generator 140. Rule 1 with the sequence of events A-B-C-D and rule 2 with the sequence of events P-R-S-T are considered as examples. According to rule 1, a correlation chain is created, but the correlator 150 receives a certain number of events A, B, C, D. In this case, the correlator 150 begins to create duplicate correlation chains according to rule 1. As a result, the correlator 150 will create several duplicate correlation chains according to rule 1 (A-B-C-D). From the example, it is evident that according to rule 1, one complete duplicate correlation chain was created, and there are also 3 incomplete duplicate correlation chains. Meanwhile, according to rule 2, the correlator 150 also created two duplicate correlation chains. In situations where a correlation chain is created but not yet fully formed, duplicate correlation chains are also created upon receiving identical events.

FIG. 2C illustrates an example of applying a correlation rule with setting the attributes of the first event in the correlation chain. In this example, four correlation chains have been created in the correlator 150 according to the rules 1, 2, 3, 4. The correlator 150, while applying the correlation rule, sets the attributes of the first events of these correlation chains. In the future, events coming from the event generator 140 are checked for similarity with set attributes of the first events of the four existing correlation chains, and then combined with existing correlation chains in case the events are duplicate. The event generator 140 then sends the following events to the correlator 150 for validation. In the figure presented, next to the completed correlation chains, duplicate events are schematically depicted, which, after a timeout of at least 60 seconds, will be combined with the existing correlation chains in the correlator 150. They will be represented as the only correlation chains in their rules, i.e. according to rule 1 there will be one correlation chain and there will also be one correlation chain for each other rule. Along with the incoming duplicate events, the correlator 150 may receive non-duplicate events, which will also be processed by the correlator 150 based on the correlation rule for duplicate events. This correlation rule also applies to correlation chains that have been created but not yet fully formed.

The example illustrated in FIG. 2C does not preclude the possibility that incoming non-duplicate events are also checked by the correlator 150 according to the rule of correlation with the set attributes of the first events of the correlation chains. In the case where the correlator 150 has not determined the similarity of the incoming events with the created correlation chains, the correlator 150 checks against other correlation rules that do not have pin_attr action, or creates new correlation chains. Other correlation rules are rules that are not related to the detection of duplicate events.

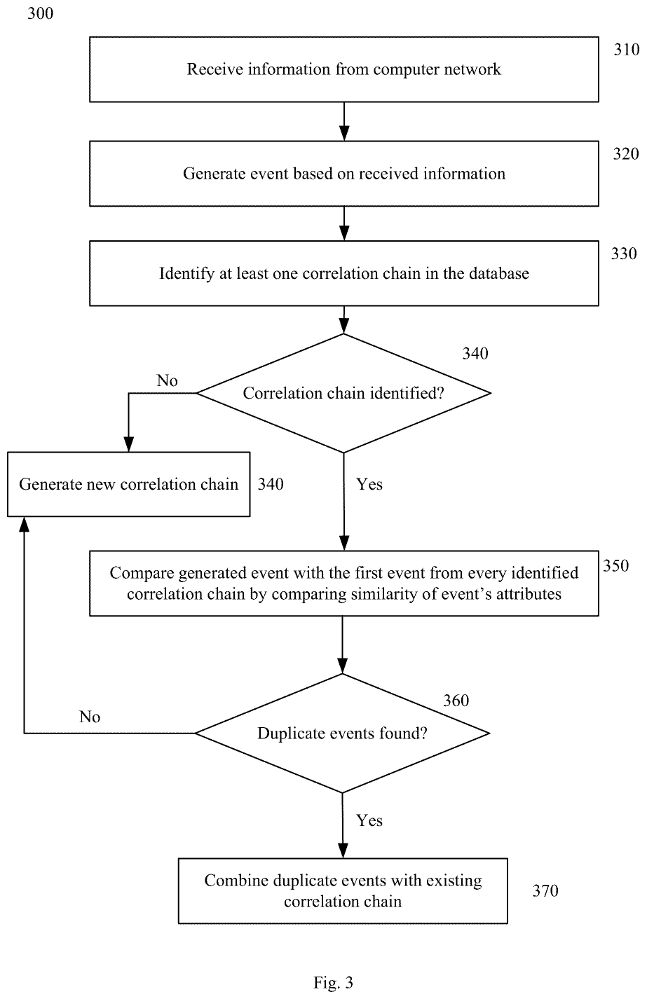

FIG. 3 illustrates a method for eliminating duplicate correlation chains of events during detection of information security incidents. The method 300 is described using the example of incoming events and checking them for similarity with the first event of the created correlation chain according to the correlation rule. To avoid the occurrence of duplicate correlation chains, the correlator 150 checks the incoming events from the event generator 140 using the correlation rule. A correlation rule contains an action that sets the attributes of the first event in the correlation chain. In the above correlation rule, the attributes of the first event are set by the pin_attr action. Further, the events arriving in the correlator 150 are checked using the same correlation rule for similarity with the first event of the existing correlation chain and combined with it in case of similarity of attributes. This rule is aimed at setting the attributes of the first event of the correlation chain, since it is the first event of the correlation chain that can create duplicate correlation chains.

Method 300 is carried out using system 100, wherein at step 310, the event generator 140 receives information from computers 110 on network 115. The information obtained includes at least information about an unauthorized network connection, the registration of a new device on the network, the disconnection of a sensor or controller, unauthorized access to the computer, etc. In one aspect, security system/software 120 further analyzes accesses from computers 110 to sources (URLs/URIs) on the Internet 170. Information is collected from computers 110 by the event generator 140 from at least computer security software 110, such as antivirus software.

In one aspect, security system/software 120 collects information from computers 110 on network 115 and then transmits it to event generator 140.

In step 320, an event is generated by the event generator 140 based on the information received, and each generated event contains attributes. The events contain at least attributes such as the event source, event type, and timestamp. In one aspect, the events contain a criticality level depending on the type of event. Generated events from the event generator 140 are passed to the correlator 150.

In step 330, the correlator 150 identifies at least one existing correlation chain in the database 160, and, for the first event of each correlation chain, sets attributes based on a corresponding correlation rule. The correlation rules contain the conditions for use and actions on the correlation chain. As indicated in the description of the system 100, the description of correlation rules can be implemented, e.g., using the YAML markup language.

Setting of the attributes of an event according to the correlation rule is carried out by the “pin_attr” action. It is worth noting that the correlation chain can consist of either one event or several consecutive events, but the pin_attr action sets the attributes of only the first event in the correlation chain. The correlation rule with sets of the attributes of the first event is used both for formed correlation chains and for correlation chains that have not yet been fully formed.

If no correlation chain is created, a new correlation chain is formed at step 340 and the attributes of the first event of the created correlation chain are set. If at least one correlation chain is created, then proceed to step 350.

In step 350, the correlator 150 compares the generated event with the first event from each defined correlation chain, during which the similarity of the attributes is determined.

If a duplicate event with the first event of the correlation chain is not found at step 360, then proceed to step 340. If a duplicate event with the first event of the correlation chain is found at step 360, then at step 370 the event with the correlation chain, namely with the first event, is combined with the event events (IDS triggering). When checking by correlator 150 events received from the event generator 140, an event with the same IP address and event type was detected, it is considered to be a duplicate event.

The correlation rule that identifies duplicate events also contains a timeout for each correlation chain. The timeout is valid for at least one minute from the time the correlator 150 starts using this correlation rule. During the timeout, the correlator 150 will check for incoming events from the event generator 140 only on this correlation rule. In a particular implementation, the correlation rule does not contain a timeout.

In one aspect, if the attributes of the generated event are not similar to the first event in at least one correlation chain, then the correlator 150 additionally compares the generated event with subsequent events from each defined correlation chain in step 350 using different correlation rules. Other correlation rules are rules that are not aimed at identifying duplicate events.

A correlation chain can consist of a single event or several consecutive events. Additional comparison of attributes on other correlation rules is necessary in cases where the correlation chain consists of several consecutive events and the correlation chain has not yet been fully formed. For example, according to the correlation rule, the correlation chain consists of a sequence of events A-B-C, and such a correlation chain has received only event A. The correlator 150 in the course of comparing the formed event, for example, B with event A of the correlation chain, did not determine the similarity of the attributes. However, as it was indicated, the correlation chain was not fully formed and it is necessary to additionally check the formed event on other correlation rules to form the correlation chain completely.

If the generated event corresponds to the next event from at least one correlation chain, the generated event is added to the corresponding correlation chain according to the correlation rule.

If the correlation chain matches a correlation rule, the correlator 150 detects an information security incident. At the same time, such a correlation chain with the detected incident will continue to be subject to the correlation rule with the set attributes of the first event until the timeout of such a correlation rule ends.

The following is an example of a correlation rule with the “pin_attr” action and set attributes such as the MAC address and event type.

```
rules:
  - rule:
    name: “policy violation”
    version: 3
    transitions:
      - transition:
        from: <start>
        to: node1
        predicate:
          - event: 4000002601
          - not_equal: {var: event.dst_address.ip, expect: 0}
        action:
          - ttl: 60
          - pin_attr: {var: event.src_address.mac, name: src_mac}
          - fire_incident:
            title: “Unauthorized network interaction detected”
            src_address.mac: $src_mac
      - transition:
        from: node1
        to: <end>
        predicate:
          - event: 0
```

The example of a rule with the “pin_attr” action contains the attributes of the event that the rule sets with the “pin_attr” action: {var: event.src_address.mac, name: src_mac} and the type of the event. At the same time, an incident title: “Unauthorized network interaction detected” was created, and a ttl timeout was set: 60, which means 60 seconds. In the future, incoming events with the same source MAC address and event type are checked against the same correlation rule and will be automatically added to the existing correlation chain or incident without creating duplicate correlation chains.

The example of a rule with the fixation of event attributes by the correlator 150 is also used for other correlation chains.

As indicated in the example, the correlation rule timeout is 60 seconds, during which incoming events will be validated and, if duplicate events are detected, combined with a known correlation chain. If duplicate events are received after a timeout of 60 seconds, they will be processed by other correlation rules without the “pin_attr” action. In one aspect, there is no correlation rule timeout. It is worth noting that the correlation rule timeout is a variable parameter and is set depending on the correlation rule.

FIG. 4 shows an example of a computer system 20 on which variant aspects of systems and methods disclosed herein may be implemented. The computer system 20 may represent the server 130 of FIG. 1 and can be in the form of multiple computing devices, or in the form of a single computing device, for example, a desktop computer, a notebook computer, a laptop computer, a mobile computing device, a smart phone, a tablet computer, a server, a cloud server, an embedded device, and other forms of computing devices.

As shown, the computer system 20 includes a central processing unit (CPU) 21, a system memory 22, and a system bus 23 connecting the various system components, including the memory associated with the central processing unit 21. The system bus 23 may comprise a bus memory or bus memory controller, a peripheral bus, and a local bus that is able to interact with any other bus architecture. Examples of the buses may include PCI, ISA, PCI-Express, HyperTransport™, InfiniBand™, Serial ATA, 12C, and other suitable interconnects. The central processing unit 21 (also referred to as a processor) can include a single or multiple sets of processors having single or multiple cores. The processor 21 may execute one or more computer-executable code implementing the techniques of the present disclosure. The system memory 22 may be any memory for storing data used herein and/or computer programs that are executable by the processor 21. The system memory 22 may include volatile memory such as a random access memory (RAM) 25 and non-volatile memory such as a read only memory (ROM) 24, flash memory, etc., or any combination thereof. The basic input/output system (BIOS) 26 may store the basic procedures for transfer of information between elements of the computer system 20, such as those at the time of loading the operating system with the use of the ROM 24.

The computer system 20 may include one or more storage devices such as one or more removable storage devices 27, one or more non-removable storage devices 28, or a combination thereof. The one or more removable storage devices 27 and non-removable storage devices 28 are connected to the system bus 23 via a storage interface 32. In an aspect, the storage devices and the corresponding computer-readable storage media are power-independent modules for the storage of computer instructions, data structures, program modules, and other data of the computer system 20. The system memory 22, removable storage devices 27, and non-removable storage devices 28 may use a variety of computer-readable storage media. Examples of computer-readable storage media include machine memory such as cache, SRAM, DRAM, zero capacitor RAM, twin transistor RAM, eDRAM, EDO RAM, DDR RAM, EEPROM, NRAM, RRAM, SONOS, PRAM; flash memory or other memory technology such as in solid state drives (SSDs) or flash drives; magnetic cassettes, magnetic tape, and magnetic disk storage such as in hard disk drives or floppy disks; optical storage such as in compact disks (CD-ROM) or digital versatile disks (DVDs); and any other medium which may be used to store the desired data and which can be accessed by the computer system 300.

The system memory 22, removable storage devices 27, and non-removable storage devices 28 of the computer system 20 may be used to store an operating system 35, additional program applications 37, other program modules 38, and program data 39. The computer system 20 may include a peripheral interface 46 for communicating data from input devices 40, such as a keyboard, mouse, stylus, game controller, voice input device, touch input device, or other peripheral devices, such as a printer or scanner via one or more I/O ports, such as a serial port, a parallel port, a universal serial bus (USB), or other peripheral interface. A display device 47 such as one or more monitors, projectors, or integrated display, may also be connected to the system bus 23 across an output interface 48, such as a video adapter. In addition to the display devices 47, the computer system 300 may be equipped with other peripheral output devices (not shown), such as loudspeakers and other audiovisual devices.

The computer system 20 may operate in a network environment, using a network connection to one or more remote computers 49. The remote computer (or computers) 49 may be local computer workstations or servers comprising most or all of the aforementioned elements in describing the nature of a computer system 20. Other devices may also be present in the computer network, such as, but not limited to, routers, network stations, peer devices or other network nodes. The computer system 20 may include one or more network interfaces 51 or network adapters for communicating with the remote computers 49 via one or more networks such as a local-area computer network (LAN) 50, a wide-area computer network (WAN), an intranet, and the Internet. Examples of the network interface 51 may include an Ethernet interface, a Frame Relay interface, SONET interface, and wireless interfaces.

Aspects of the present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store program code in the form of instructions or data structures that can be accessed by a processor of a computing device, such as the computing system 20. The computer readable storage medium may be an electronic storage device, a magnetic storage device, an optical storage device, an electromagnetic storage device, a semiconductor storage device, or any suitable combination thereof. By way of example, such computer-readable storage medium can comprise a random access memory (RAM), a read-only memory (ROM), EEPROM, a portable compact disc read-only memory (CD-ROM), a digital versatile disk (DVD), flash memory, a hard disk, a portable computer diskette, a memory stick, a floppy disk, or even a mechanically encoded device such as punch-cards or raised structures in a groove having instructions recorded thereon. As used herein, a computer readable storage medium is not to be construed as being transitory signals per se, such as radio waves or other freely propagating electromagnetic waves, electromagnetic waves propagating through a waveguide or transmission media, or electrical signals transmitted through a wire.

Computer readable program instructions described herein can be downloaded to respective computing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network interface in each computing device receives computer readable program instructions from the network and forwards the computer readable program instructions for storage in a computer readable storage medium within the respective computing device.

Computer readable program instructions for carrying out operations of the present disclosure may be assembly instructions, instruction-set-architecture (ISA) instructions, machine instructions, machine dependent instructions, microcode, firmware instructions, state-setting data, or either source code or object code written in any combination of one or more programming languages, including an object oriented programming language, and conventional procedural programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or WAN, or the connection may be made to an external computer (for example, through the Internet). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

In the interest of clarity, not all of the routine features of the aspects are disclosed herein. It would be appreciated that in the development of any actual implementation of the present disclosure, numerous implementation-specific decisions must be made in order to achieve the developer's specific goals, and these specific goals will vary for different implementations and different developers. It is understood that such a development effort might be complex and time-consuming, but would nevertheless be a routine undertaking of engineering for those of ordinary skill in the art, having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of those skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

1. A method for eliminating duplicate correlation chains of events during detection of information security incidents, comprising:
receiving information from a plurality of computers in the network;
generating an event based on the received information, wherein each generated event contains attributes;
identifying at least one correlation chain in a database, wherein, for the first event of each identified correlation chain, attributes are set based on a corresponding correlation rule;
comparing the generated event with the first event from each identified correlation chain, including determining the similarity of attributes, and further comprising:
merging an event with a correlation chain if the generated event is a duplicate event for the first event in the correlation chain, and
creating a new correlation chain if the attributes of the generated event are not similar to the attributes of the first event in the correlation chain.

2. The method of claim 1, wherein if the attributes of the generated event are not similar to the first event from at least one correlation chain, then comparing the generated event with subsequent events from each identified correlation chain using other correlation rules.

3. The method of claim 2, wherein, if the generated event corresponds to the next event from at least one correlation chain, according to the correlation rule, then adding the generated event to the corresponding correlation chain.

4. The method of claim 3, wherein, if the correlation chain corresponds with the correlation rule, an information security incident is identified.

5. The method of claim 1, wherein the information from the computers in the network includes at least information about an unauthorized network connection, registration of a new device on the network, disconnection of the sensor or controller, and/or unauthorized access to the computer.

6. The method of claim 1, wherein the similarity of the event attributes is determined according to the correlation rule during a timeout.

7. The method of claim 1, wherein the attributes of the event comprise at least a source of the event, a type of event, and/or a timestamp.

8. The method of claim 7, wherein the sources of the event includes the security features installed on the computers and/or the security software.

9. A system for eliminating duplicate correlation chains of events during detection of information security incidents, comprising:
a hardware processor configured to:
receive information from a plurality of computers in the network;
generate an event based on the received information, wherein each generated event contains attributes;
identify at least one correlation chain in a database, wherein, for the first event of each identified correlation chain, attributes are set based on a corresponding correlation rule;
compare the generated event with the first event from each identified correlation chain, including determining the similarity of attributes, and further comprising:
merge an event with a correlation chain if the generated event is a duplicate event for the first event in the correlation chain, and
create a new correlation chain if the attributes of the generated event are not similar to the attributes of the first event in the correlation chain.

10. The system of claim 9, wherein, if the attributes of the generated event are not similar to the first event from at least one correlation chain, then comparing the generated event with subsequent events from each identified correlation chain using other correlation rules.

11. The system of claim 10, wherein, if the generated event corresponds to the next event from at least one correlation chain, according to the correlation rule, then adding the generated event to the corresponding correlation chain.

12. The system of claim 11, wherein, if the correlation chain corresponds with the correlation rule, an information security incident is identified.

13. The system of claim 10, wherein the information from the computers in the network includes at least information about an unauthorized network connection, registration of a new device on the network, disconnection of the sensor or controller, an/or unauthorized access to the computer.

14. The system of claim 10, wherein the similarity of the event attributes is determined according to the correlation rule during a timeout.

15. The system of claim 10, wherein the attributes of the event comprise at least a source of the event, a type of event, and/or a timestamp.

16. The system of claim 15, wherein the sources of the event includes the security features installed on the computers and/or the security software.

17. A non-transitory computer readable medium storing thereon computer executable instructions for eliminating duplicate correlation chains of events during detection of information security incidents, including instructions for:
receiving information from a plurality of computers in the network;
generating an event based on the received information, wherein each generated event contains attributes;
identifying at least one correlation chain in a database, wherein, for the first event of each identified correlation chain, attributes are set based on a corresponding correlation rule;
comparing the generated event with the first event from each identified correlation chain, including determining the similarity of attributes, and further comprising:
merging an event with a correlation chain if the generated event is a duplicate event for the first event in the correlation chain, and
creating a new correlation chain if the attributes of the generated event are not similar to the attributes of the first event in the correlation chain.

18. The non-transitory computer readable medium of claim 17, wherein if the attributes of the generated event are not similar to the first event from at least one correlation chain, then comparing the generated event with subsequent events from each identified correlation chain using other correlation rules.

19. The non-transitory computer readable medium of claim 18, wherein, if the generated event corresponds to the next event from at least one correlation chain, according to the correlation rule, then adding the generated event to the corresponding correlation chain.

20. The non-transitory computer readable medium of claim 19, wherein, if the correlation chain corresponds with the correlation rule, an information security incident is identified.
